(19) United States
(12) Patent Application Publication
(10) Pub. No.: US 2026/0103406 A1
(43) Pub. Date: Apr. 16, 2026

(54) Fluid-powered water quality system

(71) Applicant: Antonio Davido Trigiani, Bristol, TN (US)

(72) Inventor: Antonio Davido Trigiani, Bristol, TN (US)

(21) Appl. No.: 19/356,858

(22) Filed: Oct. 13, 2025

Related U.S. Application Data
(60) Provisional application No. 63/706,323, filed on Oct. 11, 2024.

(51) Int. Cl. C02F 1/36; F03B 3/04

(52) U.S. Cl. CPC C02F 1/36; F03B 3/04; C02F 2201/009; C02F 2303/20; F05B 2220/7066

(57) ABSTRACT

Apparatus for a self-powered water quality and algae remediation system that is submerged in a body of water. The system includes a power generator module and a water quality module. The power generator module produces electrical power from fluid flow through the body of water. The water quality module includes a power supply, a controller communicating with an exciter that drives an transducer. The transducer includes a pair of blocks with one or two piezoelectric crystals positioned therebetween. In one configuration, the crystals are oriented vertically and in another configuration, the crystals are oriented horizontally. In another configuration, the transducer includes a central block and four outer blocks with crystals positioned therebetween.

### CROSS-REFERENCE TO RELATED APPLICATIONS

This application claims the benefit of U.S. Provisional Application No. 63/706,323, filed Oct. 11, 2024.

### STATEMENT REGARDING FEDERALLY SPONSORED RESEARCH OR DEVELOPMENT

Not Applicable

### BACKGROUND

### 1. Field of Invention

This invention pertains to an algae control system that is self powered. More particularly, this invention pertains to an underwater ultrasonic transducer that is powered by a fluid stream.

### 2. Description of the Related Art

Transducers that produce ultrasonic sound pressure frequencies are known to provide countermeasures in control of biofilm, algae, and other organisms in bodies of water. The algae is controlled by being exposed to ultrasonic waves propagated through bodies of water.

These bodies of water include various pools, tanks, and holding ponds such as found in consumer recreation areas and industrial plants and wastewater treatment plants. Ultrasonic transducer systems require power to operate. Often these bodies of water are located in remote locations where electrical power is not available.

### BRIEF SUMMARY

According to one embodiment of the present invention, a self-powered water quality and algae remediation system for algae control is provided. The system is self-powered because it derives its operating power from the flow of fluid, which is nominally the same fluid in which the system operates upon. The self-powered system is suitable for use with bodies of water such pools, storage tanks, sea chests, and holding tanks and ponds that have piping that moves fluid into and/or out of the body of water.

The system includes a power generator module and a water quality module. The power generator module produces power from water flow and provides that power to the water quality module. The water quality module includes a power module and a driven module. The driven module, hereafter called the transducer module, includes various devices, such as one or more ultrasonic transducers, one or more sensors, and/or lights, such as LEDs. The transducer module, in various embodiments, includes the components that monitor and impact water quality, such as by algae remediation.

The power generator module includes a turbine and a generator driven by the turbine. The turbine is driven by water flow either into or out of the water in which the system is submerged. The output of the generator powers the water quality module.

The power module of the water quality module includes a power supply and, in one embodiment, a power storage unit. The power supply is connected to the generator and converts the generator output to a level suitable for the transducer module's needs. In the embodiment with a power storage unit, the power supply also includes a two-way power connection to the power storage unit. The power storage unit includes a battery charger and a battery. In this way, the power storage unit stores power when the power generator module is operating and then provides power used by the transducer module when there is insufficient flow of liquid, such as water, to generate sufficient power from the power generator module.

The transducer module includes a controller, at least one transducer, at least one sensor, and a communications module. The controller executes software that operates the system in a prescribed manner. The controller, in one embodiment, receives an input from a sensor that provides information on water quality, such as oxygen level, turbidity, algae presence and/or concentration, etc. The controller has an output that causes the transducer to operate at a desired power level, frequency, and duty cycle. The controller, in one embodiment, is connected to the communications module, which communicates with remote units, such as a portable device and/or a communications center, which may have a wired or wireless connection.

The transducer emits ultrasonic waves into the fluid. The transducer includes a piezoelectric crystal sandwiched between a pair of blocks. In one embodiment, the piezoelectric crystal is donut-shaped and oriented vertically. In another embodiment, the piezoelectric crystal is donut-shaped and oriented horizontally.

In one embodiment, the system includes a waterproof housing that contains the power generator module and the water quality module. The system is configured to connect to a pressurized fluid source, such as a water outlet into a pool or tank. The fluid flows through the turbine and exits an exhaust port, thereby discharging the fluid into the pool or tank. In one embodiment, the turbine is bidirectional.

The sensor protrudes from the housing such that the sensor has a sensing element that is exposed to the fluid. In one embodiment, the sensor is in fluid communication with fluid flowing through the turbine.

In one embodiment, the transducer is positioned at the bottom of the housing, which is dome-shaped. In one embodiment, the transducer emits ultrasonic waves in a substantially hemispherical pattern. In various such embodiments, the transducer includes at least one block that is configured to have a hemispherical shape. In such embodiments, the transducer emits ultrasonic waves with a hemispherical wavefront, which directs the ultrasonic waves towards the sides and bottom of the body of water. In this way, when the body of water is contained in a tank or vessel, the ultrasonic waves are directed to the side and bottom surfaces of the tank or vessel to aid in algae remediation.

In another embodiment, the transducer has a cylindrical shape and emits ultrasonic waves in a substantially cylindrical pattern. In one such embodiment, the transducer emits ultrasonic waves with a cylindrical wavefront, which directs the ultrasonic waves towards the sides of the body of water. In this way, when the body of water is contained in a tank or vessel, the ultrasonic waves are directed to the side surfaces of the tank or vessel to aid in algae remediation. In yet another embodiment, the transducer is configured to be positioned adjacent a wall ultrasonic waves in a substantially half-hemispherical pattern.

### BRIEF DESCRIPTION OF THE SEVERAL VIEWS OF THE DRAWINGS

The above-mentioned features will become more clearly understood from the following detailed description read together with the drawings in which:

FIG. 1 is a functional block diagram of one embodiment of a self-powered water quality and algae remediation system.

FIG. 2 is a side view of one embodiment of a self-powered water quality and algae remediation system deployed in a fluid.

FIG. 3 is a perspective view of one embodiment of a self-powered water quality system illustrated in FIG. 2.

FIG. 4 is a top view of the embodiment of the self-powered water quality system.

FIG. 5 is a partial cross-sectional side view of one embodiment of a self-powered water quality system.

FIG. 6 is side view a block of a first embodiment of a transducer that has a vertical crystal.

FIG. 7 is side view of the first embodiment of the transducer showing two blocks with a single, vertical crystal therebetween.

FIG. 8 is an exploded diagram showing the first embodiment of the transducer shown in FIG. 6.

FIG. 9 is side view of a second embodiment of a transducer showing two blocks with a pair of vertical crystals therebetween.

FIG. 10 is an exploded diagram showing the second embodiment of the transducer shown in FIG. 9 showing two blocks with a pair of vertical crystals therebetween.

FIG. 11 is side view of a third embodiment of a transducer showing two blocks with a single, horizontal crystal therebetween.

FIG. 12 is an exploded view of the third embodiment of the transducer shown in FIG. 11.

FIG. 13 is an exploded view of a fourth embodiment of the transducer showing two blocks with a pair of horizontal crystals therebetween.

FIG. 14 is a side view of a first embodiment of radiating block having a textured surface.

FIG. 15 is a side view of a second embodiment of radiating block having a textured surface.

FIG. 16 is a perspective view of a fifth embodiment of a transducer having four crystals.

FIG. 17 is a perspective view of a sixth embodiment of a transducer configured for positioning adjacent a wall.

FIG. 18 is a perspective view of a seventh embodiment of a transducer having a cylindrical configuration.

FIG. 19 is a top view of the seventh embodiment of the transducer showing the horizontal radiation pattern.

FIG. 20 is a side view of the seventh embodiment of the transducer showing the radiation pattern as seen from the side.

### DETAILED DESCRIPTION

Apparatus for a self-powered water quality and algae remediation system is disclosed. The self-powered water quality and algae remediation system is generally indicated as 100. Various components are illustrated both generically and specifically in the figures and in the following description. For example, the transducers 130-A, 130-B are discussed individually and separately to ensure clarity when describing the configuration of each transducer 130-A, 130-B. The transducers 130, when referred to generically or collectively, are referenced without the alphanumeric suffix.

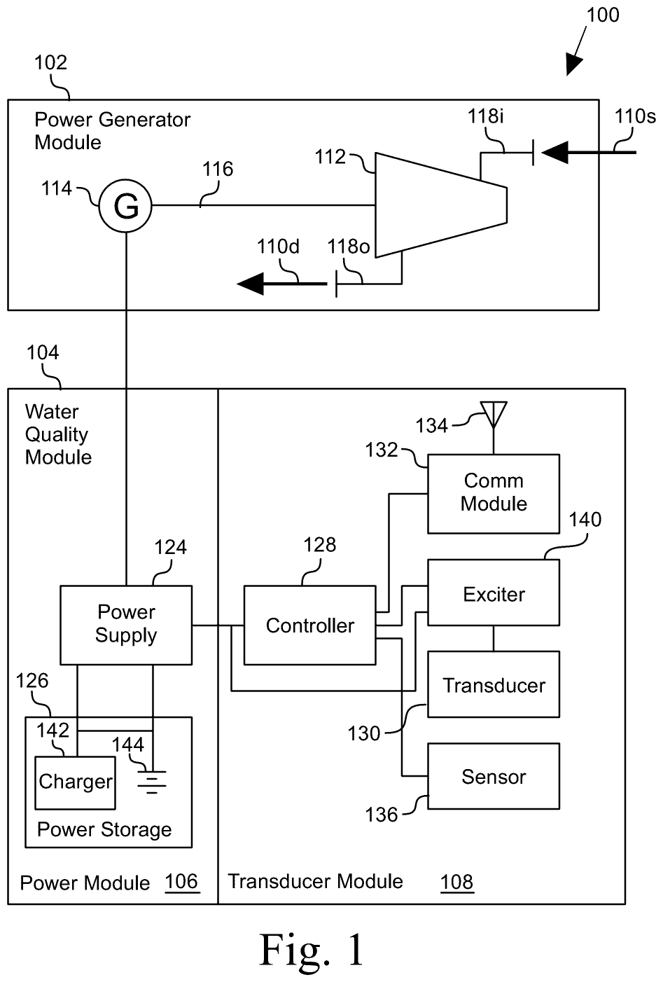

FIG. 1 illustrates a functional block diagram of one embodiment of a self-powered water quality system 100. The system 100 includes a power generator module 102 and a water quality module 104.

The power generator module 102 includes a turbine 112 and a generator 114. The turbine 112 has in inlet port 118i and an outlet port 1180. The inlet port 118i is connected to a source of pressurized fluid that flows 110s into the turbine.

The outlet port 1180 discharges fluid that flows 110d into the body of fluid in which the system 100 is submerged. In one such embodiment, the inlet port 118i is connected to a discharge port that ejects fluid into a pool or tank. In another embodiment, the outlet port 1180 is connected to a suction port that pulls fluid from the inlet port 118i through the turbine 112.

The turbine 112 has a shaft 116 connected to a generator G 114. The shaft 116 is driven to rotate by the turbine 112, thereby causing the generator 114 to produce an electrical output. In one embodiment, the shaft 116 connects the turbine 112 to the generator 114. In another embodiment, the turbine 112 and the generator 114 are an integrated unit 502 that are directly coupled.

The water quality module 104 includes a power module 106 and a transducer module 108. The power module receives power from the generator 114 in the power generator module 102. The power module 106 provides power to the transducer module 108.

The power module 106 includes a power supply 124 and, in the illustrated embodiment, a power storage unit 126 electrically connected to the power supply 124. In one embodiment, the power module 106 rectifies and conditions the output of the power generator module 102. The power supply 124 interfaces the output of the generator 114 to the transducer module 108. The power supply 124, in various embodiments, includes a voltage converter and filtering.

In the embodiment with the power storage unit 126, the power supply 124 is connected to the power storage unit 126. In one embodiment, the power storage unit 126 includes a battery charger and a battery. The battery charger charges the battery when the power generator module 102 is operating and the generator 114 is producing power. When the power generator module 102 is not operating, the battery in the power storage unit 126 provides power to the power supply 124 for operating the transducer module 108. In this way, the transducer module 108 remains powered and operational when the fluid flow 110 through the turbine 112 is insufficient for the generator 114 to provide power for the system 100.

The transducer module 108, in the illustrated embodiment, includes a controller 128, an exciter 140 connected to a transducer 130, a communications module 132 connected to an antenna 134, and a sensor 136.

The controller 128 communicates with the communication module 132, the sensor 136, the exciter 140. The controller 128 executes software that operates the system in a prescribed manner. As used herein, the controller 128 should be broadly construed to mean any device that accepts inputs and provides outputs based on the inputs and the programming of the device. For example, the controller 128 is a micro-controller, application specific integrated circuit (ASIC), an analog control device, or a computer or component thereof that executes software. In various embodiments, the controller 128 is one of a specialized device or a computer for implementing the functions of the invention. The controller 128 includes input/output (I/O) units for communicating with external devices and a processing unit that varies the output based on one or more input values. The input component of the controller 128 receives input from external devices, such as the sensor 136 and communication module 132. The output component sends output to external devices, such as the transducer 130 and the communication module 132.

The transducer 130 is driven by the exciter 140. The exciter 140 receives power from the power module 106 for driving the transducer 130. The exciter 140 is also in communication with the controller 128, which provides information to the exciter on the power level, excitation frequency, time on and time off duration, and duty cycle of the transducer 130.

The communications module 132 includes, in one embodiment, an antenna 134. The communications module 132 is connected to the controller 128. In one embodiment, the communications module 132 enables a remote device to communicate with the system 100, for example, to query the status of the system 100 and/or to set operating parameters of the system 100.

The sensor 136 monitors one or more characteristics of the fluid of the submerged system 100. For example, the sensor 130 provides information to the controller 128 on water quality, such as oxygen level, turbidity, algae presence and/or concentration, etc. In one embodiment, the sensor 136 includes a turbidity sensor that is positioned at the outlet port 1180 that discharges fluid that flows 110d into the body of fluid 210 in which the system 100 is submerged. In another embodiment, the sensor 136 protrudes from the housing 202, 204, where the sensor 136 is exposed to the fluid 210 in which the system 100 is submerged.

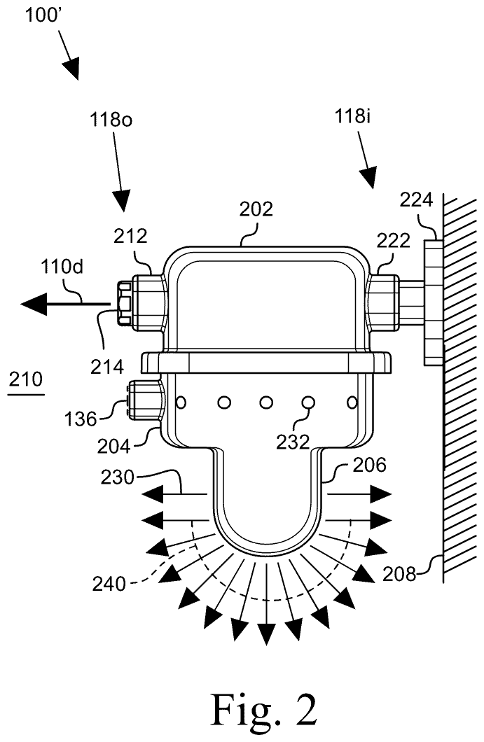

FIG. 2 illustrates a side view of one embodiment of a self-powered water quality and algae remediation system 100′ deployed in a fluid 210. The system 100′ includes an upper housing 202 and a lower housing 204.

The upper housing 202 has an inlet extension 222 with a coupler 224 that is coupled to a discharge port in a wall 208 of a pool, tank, or other container or body of fluid 210. The system 100′ is submerged in the fluid 210.

The upper housing 202 has an outlet extension 212 that discharges fluid 110d from an outlet passageway 214.

The bottom portion 206 of the lower housing 204 has a cylindrical-shape with a hemispherical bottom portion. The transducer 130 is positioned inside the bottom portion 206 of the lower housing 204. The transducer 130 emits ultrasonic waves 230 into the fluid, or body of water, 210 in directions normal to the outer surface of the bottom portion 206 of the lower housing 204. That is, each of the ultrasonic waves 230 is emitted in a direction that is perpendicular to the outer surface of the bottom portion 206 where each wave 230 is emitted. The cylindrical portion 612 of the transducer 130 emits ultrasonic waves 230 in a cylindrical wavefront 1902, which directs the ultrasonic waves 230 towards the sides of the body of water 210. The hemispherical portion 614 of the transducer 130 emits ultrasonic waves 230 in a hemispherical wavefront 240. When the system 100′ is deployed in a tank or pool or small body of water 210, the hemispherical wavefront 240 directs the ultrasonic waves 230 toward the bottom and sides of the tank or pool or small body of water 210.

In the illustrated embodiment, lights 232, such as light emitting diodes (LEDs) are spaced around the circumference of the lower housing 204. The lights 232 are operated to provide illumination in the fluid 210, such as during the night or when it is dark. In one embodiment, the lights 232 provide white illumination. In other embodiments, the lights 232 provide colored illumination that is selectively switched as desired to illuminate the fluid 210.

In one embodiment, the sensor 136 protrudes from the lower housing 204, where the sensor 136 is exposed to the fluid 210 in which the system 100 is submerged. In another embodiment, the sensor 136 protrudes from the upper housing 202. In yet another embodiment, the sensor 136 is attached to the outlet extension 212 with the sensor 136 in fluid communication with the outlet passageway 214.

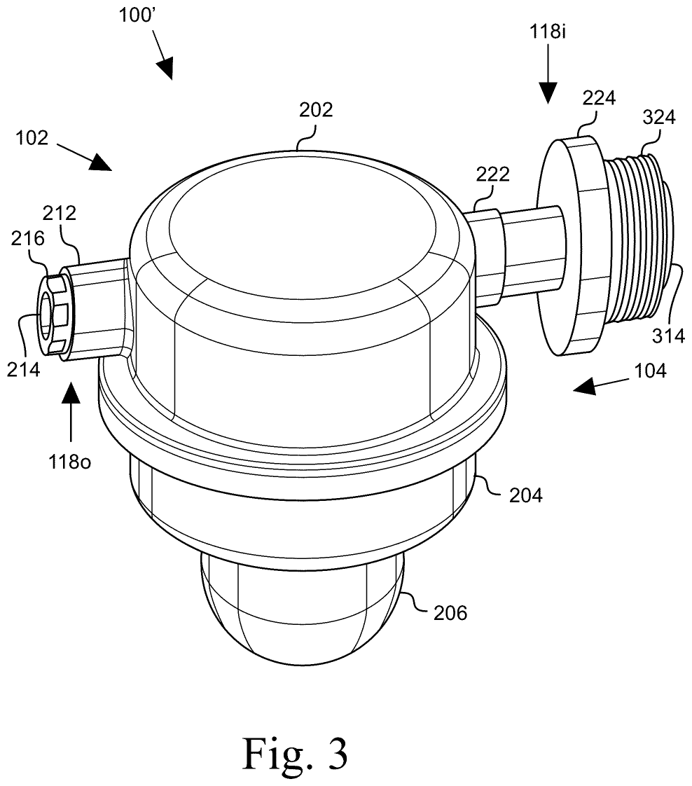

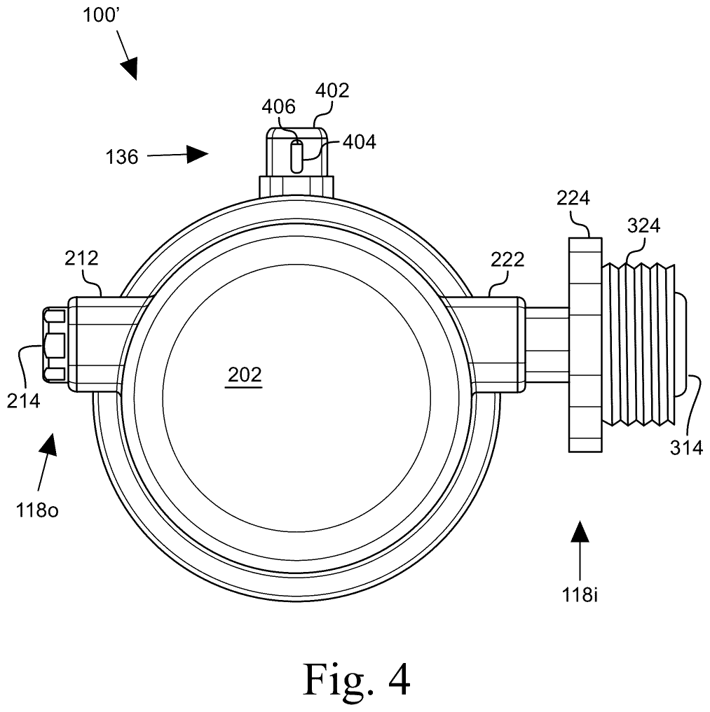

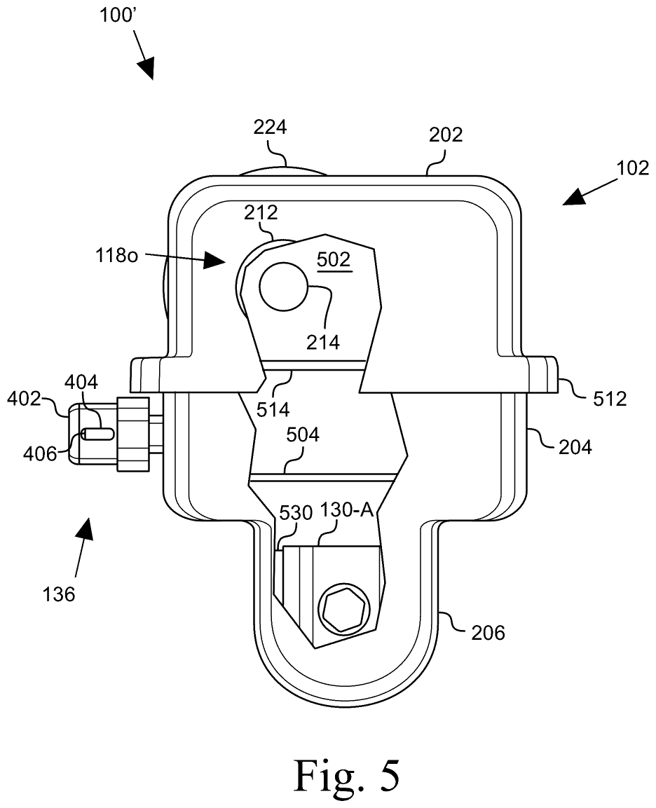

FIG. 3 illustrates a perspective view of one embodiment of a self-powered water quality and algae remediation system 100′ illustrated in FIG. 2. FIG. 4 illustrates a top view of the embodiment of the self-powered water quality and algae remediation system 100′. FIG. 5 illustrates a partial cross-sectional side view of one embodiment of a self-powered water quality and algae remediation system 100′.

The system 100′ includes an upper housing 202 and a lower housing 204. The bottom rim 512 of the upper housing 202 is attached to the upper portion 514 of the lower housing 204 with a water-tight connection. In this way, the inside of the upper and lower housings 202, 204 are sealed from the fluid 210 outside the housings 202, 204.

The upper housing 202 comprises the power generator module 102. The upper housing 202 encloses the integrated unit 502 that includes the turbine 112 and the generator 114. Extending from one side of the upper housing 202 is the inlet port 118i and from the opposite side is the outlet port 1180. The illustrated embodiment of the inlet port 118i includes an inlet extension 222 from the upper housing 202, a coupler 224, and an inlet passageway 314. The coupler 224 includes a threaded portion 324 configured to engage an exhaust port in the wall 208. The exhaust port in the wall 208 ejects a flow 110s of fluid 210 into the inlet port 118i. The inlet passageway 314 is in fluid communicates with the turbine 112.

The illustrated embodiment of the outlet port 1180 includes an outlet extension 212 from the upper housing 202 and a nozzle 216. The nozzle 216 includes an outlet passageway 214 in fluid communicates with the turbine 112.

The lower housing 204 encloses the transducer 130 in a lower portion 206. The lower portion 206 is a hollow cylinder with a dome-shaped bottom. In the illustrated embodiment, the transducer 130-A is secured in the lower portion 206 with a potting compound 530. The potting compound 530 and the material of the lower portion 206 allow the passage of ultrasonic waves from the transducer 130 with minimal attenuation. In another embodiment, the potting compound 530 covers both the PCB 504 and the transducer 130-A.

Extending from the lower housing 204 into the external fluid 210 is the sensor 136. In the illustrated embodiment, the sensor 136 includes a sensor enclosure 402 with openings 404 spaced about its periphery. The openings 404 allow for free passage of the fluid into and through the sensor enclosure 402 such that the sensor element 406 is exposed to the fluid.

In the illustrated embodiment, the upper housing 202 and the lower housing 204 also encloses, between the integrated unit 502 and the transducer 130, a printed circuit board (PCB) 504 that includes a portion of the electrical circuit making up the water quality module 104. In one embodiment, the PCB 504 includes the power supply 124, the controller 128, the communications module 132 and antenna 134, and the exciter 140. In one such embodiment, the PCB 504 also includes the power storage unit 126. In the embodiment with a sensor 136, the sensor element 406 includes electrical connections to the PCB 504.

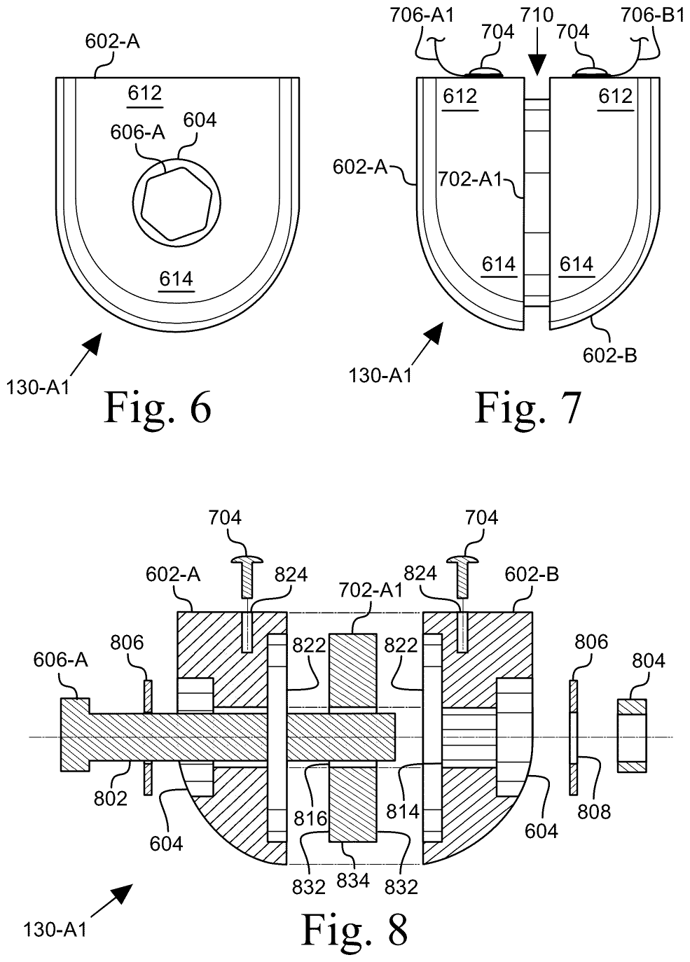

FIG. 6 illustrates a side view a block of a first embodiment of a transducer 130-A1 that has a vertical crystal 702-A1. FIG. 7 illustrates a side view of the first embodiment of the transducer 130-A1 showing two blocks 602-A, 602-B with a single, vertical crystal 702-A1 therebetween. FIG. 8 illustrates an exploded diagram showing the first embodiment of the transducer 130-A1 shown in FIGS. 6 and 7.

The transducer 130-A1, with the two blocks 602-A, 602-B and the single, sandwiched piezoelectric crystal 702-A1, defines a cylindrical-shape with a hemispherical end. Each block 602-A, 602-B includes an upper or cylindrical portion 612 and a lower or hemispherical portion 614. The upper portions 612 of the pair of blocks 602 substantially define a cylinder. The lower portions 614 of the pair of blocks 602 substantially define a hemisphere. The cylindrical portion 612 of the transducer 130-A1 emits ultrasonic waves 230 360-degrees completely around the circumference of the cylindrical portion 612. The hemispherical portion 614 of the transducer 130-A1 emits ultrasonic waves 230 180-degrees centered around the longitudinal axis of the transducer 130-A1.

A gap 710 is defined by the space between the blocks 602-A, 602-B. In one embodiment, the gap 710 is an air space between the 602-A, 602-B where the air gap 710 provides electrical isolation between the 602-A, 602-B. In another embodiment, the gap 710 includes a sheet insulator, such as paper or thin plastic between the 602-A, 602-B where the sheet insulator in the air gap 710 provides electrical isolation between the 602-A, 602-B. The transducer 130-A1 is surrounded by the housing 206. The gap 710 is sufficiently small that the ultrasonic waves 230 emitted from each block 602-A, 602-B expand and merge into a circular wavefront 1902 below or at the surface of the housing 206 surrounding the transducer 130-A1. Accordingly, the gap 710 is such that the ultrasonic waves 230 emitted from the transducer 130-A1 are not impacted and the ultrasonic waves 230 are emitted 360-degrees around substantially the full circumference of the cylindrical portion 612 of the transducer 130-A1 and 180-degrees around the hemispherical portion 614 of the transducer 130-A1.

In one embodiment, the pair of blocks 602 are made from cylindrical stock with a hemispherical end. The stock is cut longitudinally into two substantially equal halves. In another embodiment, the pair of blocks 602 are made from cylindrical stock with a hemispherical end. The stock is cut longitudinally with sufficient material removed that the transducer 130-A1, when assembled with the crystal 702-A1, has an upper portion 612 that is cylindrical.

Each block 602-A, 602-B includes a blind opening 824 that each receives a fastener 704 that secures an electrical connection 706-A1, 706-B1 to a respective block 602-A, 602-B. The electrical connections 706-A1, 706-B1 are in electrical communication with the exciter 140. In one embodiment, the electrical connections 706-A1, 706-B1 each include a ring or spade terminal that is secured under the corresponding fastener 704. Each of the blocks 602-A, 602-B provides an electrical connection to the corresponding face of the crystal 702-A1.

The piezoelectric crystal 702-A1 has a donut-shape, that is, it is disc-shaped with an opening 816 in the center between the two opposing faces 832. Between the opposing faces 832 of the crystal 702-A1 is the outer, cylindrical surface 834. A property of a piezoelectric crystal 702 is that the crystal 702 vibrates when excited by an electrical signal. In the illustrated embodiment, each block 602-A, 602-B is electrically connected and mechanically coupled to the corresponding face 832 of the crystal 702-A1. The mechanical coupling can be by way of a fastener 606 and/or a conductive adhesive such as an epoxy. In this way, the vibrations generated by the crystal 702-A1 are optimally coupled to the blocks 602-A, 602-B.

Each of the opposing faces 832 of the crystal 702-A1 is received in a recess 822 in each of the adjacent blocs 602. A fastener 606-A and corresponding nut 804 pass through openings 604, 814, 816 in the blocks 602 and the crystal 702-A1. In this way the crystal 702-A1 is compressed between the blocks 602-A, 602-B with a secure connection such that the mechanical vibrations of the crystal 702-A1, when excited, are transmitted through the blocks 602-A, 602-B. the fastener 606-A is electrically insulated from the blocs 602 by the insulated washers 806 and the oversized openings 604, 814, 816 in the blocks 602 and the crystal 702-A1. The openings in the insulated washers 806 are sized to hold the shaft 802 of the fastener 606-A in the center of the oversized openings 604, 814, 816 in the blocks 602 and the crystal 702-A1, thereby ensuring that the shaft 802 does not make electrical contact with the blocks 602 and the crystal 702-A1.

The blocks 602-A, 602-B each include an opening 604. The opening 604 in block 602-A receives an insulated washer 606 and the head of the fastener 606-A. The opening 604 in the other block 602-B receives an insulated washer 606 and the nut 804. The openings 604 have a depth sufficient to minimize the protrusion of the fastener 606-A and the distal end of the shaft 802 with its corresponding nut 804 beyond the contour of the outer surface of the blocks 602. In one embodiment, the opening 604 in block 602-B is threaded and the washer 806 and nut 804 are not used.

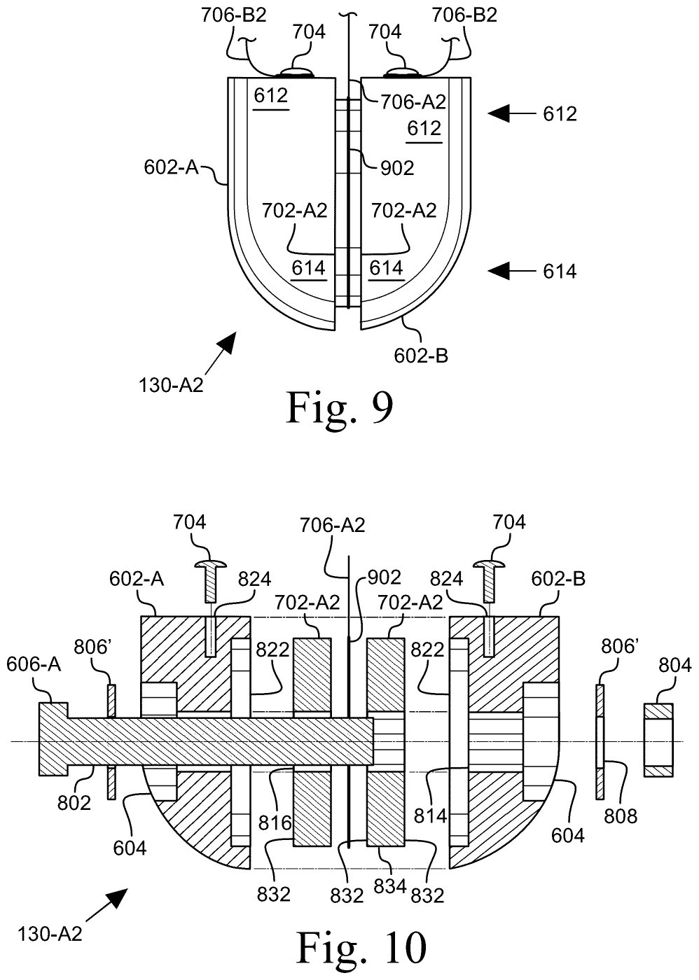

FIG. 9 illustrates a side view of a second embodiment of a transducer 130-A2 showing two blocks 602-A, 602-B with a pair of vertical crystals 702-A2 therebetween. FIG. 10 illustrates an exploded diagram showing the second embodiment of the transducer 130-A2 shown in FIG. 9 showing two blocks 602-A, 602-B with a pair of vertical crystals 702-A2 therebetween.

The transducer 130-A2, with the two blocks 602-A, 602-B and the two, sandwiched piezoelectric crystals 702-A2, defines a cylindrical portion 612 with a hemispherical end 614. Each block 602-A, 602-B includes an upper portion 612 and a lower portion 614. The upper portions 612 of the pair of blocks 602 substantially define a cylinder. The lower portions 614 of the pair of blocks 602 substantially define a hemisphere.

In one embodiment, the pair of blocks 602 are made from cylindrical stock with a hemispherical end. The stock is cut longitudinally into two substantially equal halves. In another embodiment, the pair of blocks 602 are made from cylindrical stock with a hemispherical end. The stock is cut longitudinally with sufficient material removed that the transducer 130-A2, when assembled with the crystals 702-A2, has an upper portion 612 that is cylindrical.

In the illustrated embodiment, the two, donut-shaped crystals 702-A2 are positioned side-by-side and separated by a conductive sheet 902 that electrically connects the pair of crystals 702-A2. An electrical connection 706-A2 provides electrical communication between where the two crystals 702-A2 come together and the exciter 140. The other electrical connection 706-B2 between the crystals 702-A2 and the exciter 140 is provided through one or both of the blocks 602-A, 602-B. In the illustrated embodiment, the washers 806′ are conductive, as is the fastener 606-A. In this way, the two blocks 602-A, 602-B are electrically connected. In such an embodiment, only one of the electrical connections 706-B2 is needed. In another embodiment, both the electrical connections 706-B2 are used to connect to the exciter 140, thereby ensuring that each crystal 702-A2 is electrically connected to the exciter 140.

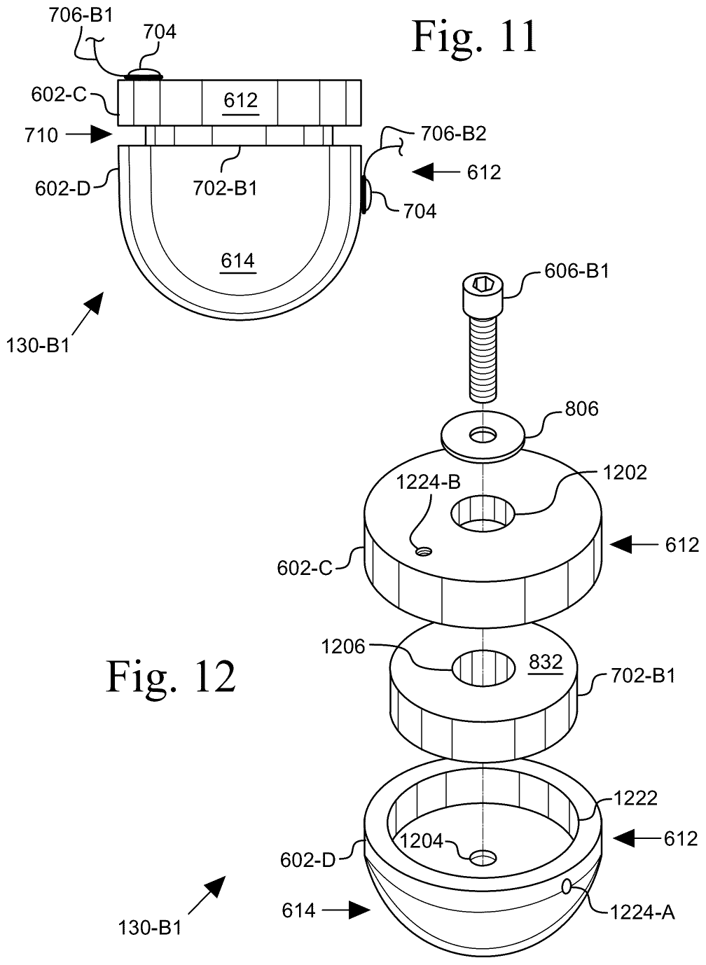

FIG. 11 illustrates a side view of a third embodiment of a transducer 130-B1 showing two blocks 602-C, 602-D with a single, horizontal crystal 702-B1 therebetween. FIG. 12 illustrates an exploded view of the third embodiment of the transducer 130-B1 shown in FIG. 11.

The transducer 130-B1, with the two blocks 602-C, 602-D and the single, sandwiched piezoelectric crystal 702-B1, defines a cylindrical portion 612 and a hemispherical end 614. The upper block 602-C has a cylindrical portion 612 that is defined by a cylinder. The block 602-C is disc-shaped with cylindrical sides. The lower block 602-D includes an upper portion 612 and a lower portion 614. The block 602-D has a short cylindrical portion 612 above a lower portion 614 that is hemispherical. The upper block 602-C has a blind hole 1224-B that receives a fastener 704 that secures an electrical connection 706-B1 to the upper block 602-C. The lower block 602-D has a blind hole 1224-A that receives a fastener 704 that secures an electrical connection 706-B2 to the lower block 602-D.

The piezoelectric crystal 702-B1 is positioned between the two blocks 602-C, 602-D. In the illustrated embodiment, the lower block 602-D has a recess 1222 that receives one flat side of the crystal 702-B1. Each block 602-C, 602-D makes electrical contact with crystal 702-B1.

A fastener 606-B1 engages an insulated washer 806 that sits atop the upper block 602-C. The fastener 606-B passes through the opening 1202 in the upper block 602-C and the opening 1206 in the crystal 702-B1. The two openings 1202, 1206 are larger than the diameter of the shaft of the fastener 606-B1 so that the fastener 606-B1 does not make electrical contact with the upper block 606-C and the crystal 702-B1. The distal end of the fastener 606-B1 engages a threaded opening 1204 in the recess 1222 of the lower block 602-D.

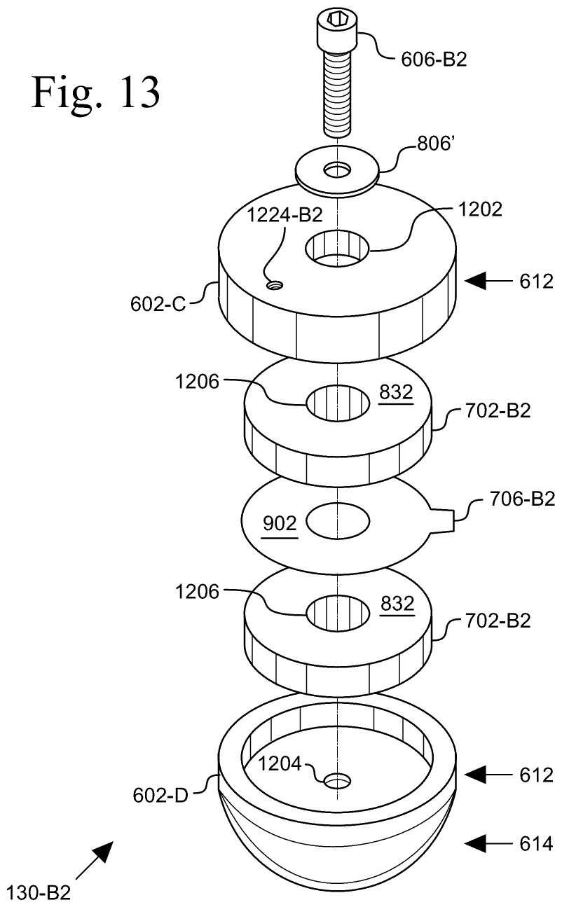

FIG. 13 illustrates an exploded view of a fourth embodiment of the transducer 130-B2 showing two blocks 1102, 1104 with a pair of horizontal crystals 702-B2 therebetween. The fourth embodiment of the transducer 130-B2 is similar to the third embodiment of a transducer 130-B1 shown in FIGS. 11 & 12 with the exception that there are two crystals 702-B2, a conductive sheet 902 positioned therebetween, and the washer 806′ is conductive. In this way, the fourth embodiment of the transducer 130-B2 is electrically similar to the second embodiment of the transducer 130-A2 illustrated in FIGS. 9 & 10.

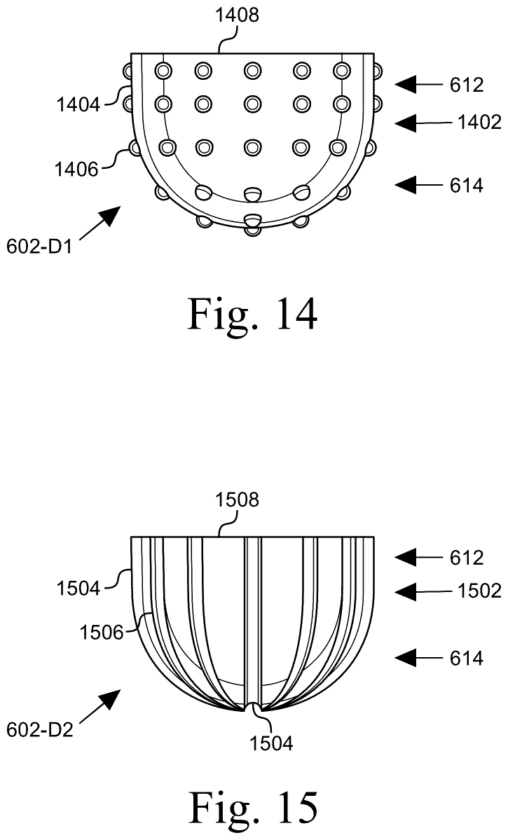

FIG. 14 illustrates a side view of a first embodiment of radiating block 602-D1 having a textured surface 1404. In the illustrated embodiment, the radiating block 602-D1 is similar to the block 602-D illustrated in FIGS. 11-13. In other embodiments, the textured surface 1404 illustrated on radiating block 602-D1 is used on other configurations of the block 602, such the ones illustrated in FIGS. 6-10 and 16-20.

The block 602-D1 has a body 1402 with a textured surface 1404 over the lower portion of the body 1402 that is away from the piezoelectric crystal 702 that is adjacent the upper surface 1408 of the block 1402. The textured surface 1404 includes multiple protrusions 1406 that are spaced around the textured surface 1404. In various embodiments, some or all of the protrusions 1406 are replaced with depressions.

FIG. 15 illustrates a side view of a second embodiment of radiating block 602-D2 with a textured surface 1504. In the illustrated embodiment, the radiating block 602-D1 is similar to the block 602-D illustrated in FIGS. 11-13. In other embodiments, the textured surface 1504 illustrated on radiating block 602-D1 is used on other configurations of the block 602, such the ones illustrated in FIGS. 6-10 and 16-20.

The block 602-D2 has a body 1502 with a textured surface 1504 over the lower portion of the body 1502 that is away from the piezoelectric crystal 702 that is adjacent the upper surface 1508 of the block 1502. The textured surface 1504 includes multiple channels 1506 that are spaced around the textured surface 1504. The channels 1506 extend from the upper surface 1508 to the distal end of the body 1502. In various embodiments, some or all of the channels 1506 are replaced with protrusions that extend from the upper surface 1508 to the distal end of the body 1502. In yet another embodiment, some or all of the channels 1506 are replaced with a series of flat, faceted surfaces.

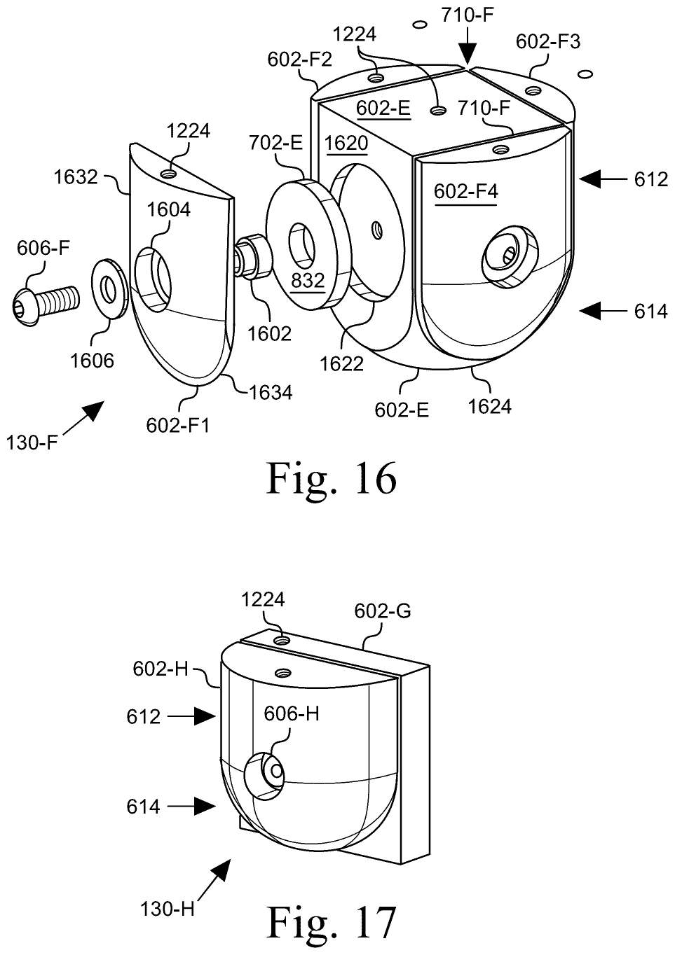

FIG. 16 illustrates a perspective view of a fifth embodiment of a transducer 130-F having four crystals 702-E. The illustrated embodiment of the transducer 130-F has a central block 602-E and four outer blocks 602-F1, 602-F2, 602-F3, 602-F4. The four outer blocks 602-F each have a piezoelectric crystal 702-E sandwiched between each outer block 602-F and the central block 602-E. Each piezoelectric crystal 702-E engages a corresponding one of a recess 1622. A fastener 606-F engages an insulating flat washer 1606, an opening 1604 in one of the outer blocks 602-F, an insulating stepped washer 1602 that isolates the outer block 602-F from the crystal 702-E and the central block 602-E.

The central block 602-E has an upper portion with four planar surfaces 1620. The four planar surfaces 1620 are positioned around the upper portion of the central block 602-E, with each planar surface 1620 positioned 90 degrees relative to adjacent ones of the planar surfaces 1620. In the illustrated embodiment, each planar surface 1620 includes a recess 1622 sized to receive a portion of a piezoelectric crystal 702-E. The central block 602-E has a distal end 1624 defined by a hemisphere. The end of the planar surfaces 1620 proximate the distal end 1624 cut into the hemispherical shape of the distal end 1624.

The four outer blocks 602-F each have an upper portion 1632 with a first arcuate surface and a lower portion 1634 with a second arcuate surface that is a portion of a spherical surface defined by a hemisphere that includes the distal end 1624 of the central block 602-E. That is, when the four outer blocks 602-F are positioned proximate the corresponding planar surface 1620 with the corresponding crystal 702-E positioned therebetween, the upper ends 1632 of the outer blocks 602-F define a substantially cylindrical shape and the distal ends 1624, 1634 of the central block 602-E and the four outer blocks 602-F1, 602-F2, 602-F3, 602-F4 define a substantially hemispherical shape.

The adjacent edges of the outer blocks 602-F define a gap 710-F where the outer blocks 602-F are slightly separated. The gap 702-F extends along the sides of the outer blocks 602-F downward where the gaps 710-F are defined by the edges of the outer blocks 602-F and the central block 602-E.

The illustrated embodiment of the transducer 130-F emits ultrasonic waves 230 as illustrated in FIG. 2. With four piezoelectric crystals 702-E, the transducer 130-F is capable of emitting stronger waves 230 when using similar sized crystals 702 as illustrated in the other embodiments. Alternatively, when it is desired to emit waves 230 of the same strength as illustrated in other embodiments, the crystals 702-E for the illustrated transducer 130-F require less power than would be required for one crystal 702 configured to emit ultrasonic waves 230 in all directions.

FIG. 17 illustrates a perspective view of a sixth embodiment of a transducer 130-H configured for positioning adjacent a wall. The illustrated embodiment of the transducer 130-H has a first block 602-G and a second block 602-H. The two blocks 602-G, 602-H are connected together with a fastening system 606-H, similar to that illustrated in FIG. 16. The sandwiching of the piezoelectric crystal 702 between the pair of blocks 602-G, 602-H is similar to the construction of the embodiments illustrated in FIGS. 6-10.

In the illustrated embodiment of the transducer 130-H, the first block 602-G is a rectangular solid. The second block 602-H has a shape similar to the shape of one of the blocks 602-A, 602-B shown in FIGS. 6-10. The first block 602-G is separated from the second block 602-H by a gap 710-H. The transducer 130-H is configured to emit ultrasonic waves 230 primarily from the second block 602-H and not the first block 602-G. The first block 602-G is configured to be positioned adjacent a wall or support structure 208. In this way, the energy from the crystal 702 is directed outward from the second block 602-H in a horizontal and vertical direction in a half-hemispherical pattern.

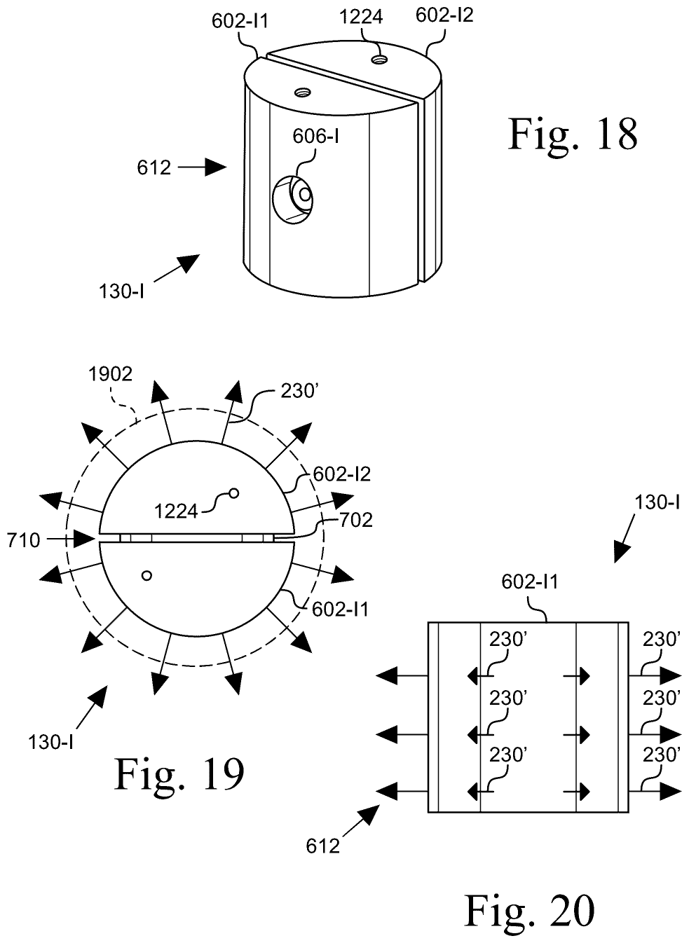

FIG. 18 illustrates a perspective view of a seventh embodiment of a transducer 130-I having a cylindrical configuration. The illustrated embodiment of the transducer 130-I has a pair of blocks 602-I1, 602-I2 that each have a half-cylindrical shape, together, define a vertically-oriented cylinder. The two blocks 602-I1, 602-I2 are connected together with a fastening system 606-I, similar to that illustrated in FIG. 16. The sandwiching of the piezoelectric crystal 702 between the pair of blocks 602-I1, 602-I2 is similar to the construction of the embodiments illustrated in FIGS. 6-10. At the top of the two blocks 602-I1, 602-I2 are threaded openings 1224 configured to receive threaded fasteners and lugs for making the electrical connections to the two blocks 602-I1, 602-I2 for exciting the piezoelectric crystal 702.

FIG. 19 is a top view of the seventh embodiment of the transducer 602-I showing the horizontal radiation pattern. The cylindrical embodiment of the transducer 130-I uses a single piezoelectric crystal 702 to emit ultrasonic waves 230′ in a 360 degree pattern horizontally, that is, in a plane perpendicular to the longitudinal axis of the cylindrical-shaped transducer 130-I. In the illustrated embodiment, the 360-degree horizontal pattern is shown as a series of ultrasonic waves 230′ that produce a cylindrical wavefront 1902 that emanates from the transducer 130-I. The illustrated cylindrical wavefront 1902 represents the circumference of radiation emitting from the transducer 130-I.

The gap 710 is defined by the space between the blocks 602-I1, 602-I2. The gap 710 is sufficiently small such that the ultrasonic waves 230′ emitted from the transducer 130-I are not impacted and the waves 2301 are emitted around the full circumference of the transducer 130-I, that is, the ultrasonic waves 230′ are emitted a full 360 degrees around the vertical or longitudinal axis of the transducer 130-I. The gap 710 is sufficiently narrow that there are no nulls in the radiation pattern of ultrasonic waves 230′ around the transducer 130-I. Furthermore, the transducer 130-I is surrounded by the housing 206. The gap 710 is sufficiently small that the ultrasonic waves 230 emitted from each block 602-I1, 602-I2 expand and merge into a cylindrical wavefront 1902 below or at the surface of the housing 206 surrounding the transducer 130.

For example, in one embodiment the gap 710 is about 0.050 inches, which is substantially insignificant relative to the approximate 3.0 inch diameter of the transducer 130-I. The cylindrical shape of the transducer 130-I vibrates from the excitation of the piezoelectric crystal 702 and the entire surface of the transducer 130-I emits ultrasonic waves 230′ in a direction normal to the transducer surface.

FIG. 20 is a side view of the seventh embodiment of the transducer 602-I showing the radiation pattern as seen from the side. The cylindrical embodiment of the transducer 130-I emits ultrasonic waves 230′ in a horizontal plane where the plane is perpendicular to the central axis of the cylindrical transducer 130-I. Substantially all the energy from the crystal 702 is emitted from the sidewalls of the cylindrical transducer 130-I. Very little of the energy is transmitted from the top and bottom of the cylindrical transducer 130-I.

As used herein, normal is defined as a direction perpendicular to a tangent at a point on the surface. In the case of a cylindrical object, such as the cylindrical portion 612 of a transducer 130, normal coincides with a radial direction, that is, perpendicular to the longitudinal or central or cylindrical axis. In the case of a spherical or partially spherical object, such as the spherical portion 614 of a transducer 130, normal coincides with a radial direction, that is, a direction perpendicular to the center of the sphere.

The self-powered water quality and algae remediation system 100 includes various functions. The function of being self powered is implemented by being able to obtain power from the environment surrounding the system 100. In one embodiment, the function of being self-powered is implemented by a turbine 112 connected to a generator 114 whereby the turbine 112 is subject to a flow 110s of fluid 210.

The function of emitting ultrasonic waves in a hemispherical pattern is implemented, in one embodiment, by the transducer 130 having blocks 602 that have a substantially hemispherical shape. With the piezoelectric crystal 702 coupled to the one or more blocks 602, the ultrasonic waves are emitted in a direction normal to the hemispherical surface of the blocks 602.

The function of emitting ultrasonic waves in a 360 degree horizontally oriented pattern or circular wavefront 1902 is implemented, in one embodiment, by the transducer 130 having blocks 602 that have a portion that have a substantially cylindrical shape. For example, FIGS. 6-16 and 18-20 illustrate transducers with blocks 602-A, 602-B, 602-D, 602-D1, 602-D2, 602-F1, 602-F2, 602-F3, 602-F4, 602-I1, 602-I2 that have an portion that is cylindrical. In this way, the ultrasonic waves are emitted in a direction normal to the cylindrical surface of the blocks 602. In another embodiment, the function of emitting ultrasonic waves with a 360-degree circular wavefront 1902 is implemented by mechanically coupling the opposing faces 832 of the piezoelectric crystal 702 with a corresponding one of the blocks 602. In such an embodiment, each block 602 emits ultrasonic waves 230. In one such embodiment, at least one of the blocks 602 have a cylindrical portion 612. In another such embodiment, both blocks 602, together, define a cylindrical portion 612.

The function of emitting ultrasonic waves in a 360 degree horizontally oriented pattern or circular wavefront 1902 is implemented, in one embodiment, by the transducer 130 having a gap 710 between the vertically oriented blocks 602-A, 602-B, 602-I1, 602-I2 where the gap 710 is substantially smaller than the diameter of the transducer 130-A1, 130-A2, 130-B1, 130-B2, 130-I. In one embodiment, the gap 710 is an air gap providing electrical insulation between the blocks 602. In another embodiment the air gap 710 includes an insulating sheet, such as paper or thin plastic. In one example, in one embodiment the gap 710 is about 0.050 inches, which is substantially insignificant relative to the approximate 3.0 inch diameter of the transducer 130-I. The gap 710 is sufficiently small that the ultrasonic waves 230 emitted from each block 602 expand and merge into a circular wavefront 1902 below or at the surface of the housing 206 surrounding the transducer 130.

The function of minimizing power consumption while emitting a 360-degree circular wavefront 1902, in one embodiment, is implemented by mechanically coupling the opposing faces 832 of the piezoelectric crystal 702 with a corresponding one of the blocks 602 where at least one of the blocks 602 define a cylindrical portion 612 and each block 602 emits ultrasonic waves 230 into the surrounding water or fluid 210. In this way, one piezoelectric crystal 702 provides 360-degree circular wavefront 1902 using one-fourth the power of a system that requires four crystals to provides 360-degree circular wavefront 1902. Likewise, one piezoelectric crystal 702 provides 360-degree circular wavefront 1902 using one-half the power of a system that requires two crystals to provides 360-degree circular wavefront 1902. For example, the one crystal 702 transducers 130-A1, 130-B1, 130-I require 20 watts electrical power to produce the same intensity ultrasonic waves 130 compared to the 40 watts required by the prior art transducers that require two crystals to emit waves 230 in four quadrants.

From the foregoing description, it will be recognized by those skilled in the art that a self-powered water quality and algae remediation system 100 has been provided. The system 100 includes a power generator module 102 and a water quality module 104. The power generator module 102 generates electrical power from a stream of fluid 110s. The power generator module 102 includes a turbine 112 and a generator 114. The water quality module 104 includes a transducer module 108 that uses the generated power to emit ultrasonic waves at a pre-determined power level, frequency, time on duration, and duty cycle. The transducer module 108 includes a controller, an exciter, and a transducer.

In one embodiment, the transducer 130 efficiently converts electrical power into ultrasonic waves 230 by using a single piezoelectric crystal 702 to produce a cylindrical wavefront 1902 of ultrasonic waves 230. Also, in various embodiments, the transducer 130 efficiently converts electrical power into ultrasonic waves 230 by using a single piezoelectric crystal 702 to produce a hemispherical wavefront 240 of ultrasonic waves 230. Various embodiments of the transducer include a single or a pair of piezoelectric crystals 702 between a pair of blocks 602. The blocks 602 are mechanically coupled to the crystal 702 such as by a fastener 606 that compresses the crystal 702 between the blocks 602 and/or by a conductive adhesive. Furthermore, the electrical connection to the opposing faces 832 of the piezoelectric crystal 702 is made through a corresponding one of the blocks 602, which are electrically conductive. In other embodiments, the transducer 130 includes a piezoelectric crystal 702 and one or more blocks configured to emit ultrasonic waves 230. In such embodiments, the blocks can be rectangular or disc-shaped.

In various embodiments, the transducer 130 has a cylindrical portion 612 and/or a hemispherical portion 614. The cylindrical portion 612 emits ultrasonic waves 230 having a cylindrical wavefront 1902. The transducer 130 is enclosed in a housing 206 and which allows the ultrasonic waves 230 to have a full 360-degree cylindrical wavefront 1902 because the gap 710 between the blocks 602 is sufficiently small that the waves 230 expand and meet by the time the waves 230 pass through the housing 206 into the water 210. On one embodiment, the transducer 130-H has a half-cylindrical portion 612-h and a half-hemispherical portion 614-h. In other embodiments, the transducer 130 includes a piezoelectric crystal 702 and one or more blocks configured to emit ultrasonic waves 230 in a pattern other than cylindrical or hemispherical.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for a fluid-powered water quality and algae remediation system for immersion in water, said apparatus configured to attach to a fluid port through which a stream of fluid flows, said apparatus comprising:
a turbine configured to be operatively connected to the fluid port through which the stream of fluid flows,
a generator operatively connected to said turbine, said turbine and said generator producing electrical power from the stream of fluid; and
a water quality module that includes a controller, an exciter, and a transducer, said water quality module powered by said power generator module, said controller operatively connected to said exciter, said exciter operatively connected to said transducer whereby said transducer is controlled to emit ultrasonic waves.

2. The apparatus of claim 1 wherein said turbine has an inlet and an outlet, said turbine connected to said generator such that said generator produces electrical power by rotation of an output shaft of said turbine, and said rotation being induced by the stream of fluid flowing between said inlet and said outlet of said turbine.

3. The apparatus of claim 1 wherein said water quality module includes a power supply and a transducer module, said power supply configured to convert the power from said power generator module to a voltage suitable for said transducer module, and said transducer module including said controller, said exciter, and said transducer.

4. The apparatus of claim 1 wherein said water quality module includes a sensor responsive to a characteristic of the water.

5. The apparatus of claim 1 wherein said transducer includes a piezoelectric crystal in electrical communication with said exciter; said transducer further including a pair of blocks wherein at least one of said pair of blocks define a cylindrical shape and said at least one of said pair of blocks emits ultrasonic waves with a cylindrical wavefront when said piezoelectric crystal is excited by said exciter.

6. The apparatus of claim 1 wherein said transducer includes a piezoelectric crystal in electrical communication with said exciter; and said transducer further including a pair of blocks wherein at least one of said pair of blocks define a hemispherical shape and said at least one of said pair of blocks emits ultrasonic waves with a hemispherical wavefront when said piezoelectric crystal is excited by said exciter.

7. The apparatus of claim 6 wherein said pair of blocks include a first block having a first portion defined by a cylinder and a second portion defined by a hemisphere; and said piezoelectric crystal engaging said first portion of said first block.

8. The apparatus of claim 6 wherein said pair of blocks together have a first portion defined by a cylinder and a second portion defined by a hemisphere; and said piezoelectric crystal positioned between said pair of blocks.

9. The apparatus of claim 6 wherein said pair of blocks include a first block and a second block; said first block having a first portion defined by one-half of a cylinder and having a second portion defined by one half of a hemisphere; said second block having a shape defined by a rectangular solid; and said piezoelectric crystal positioned between said first and second blocks.

10. The apparatus of claim 1 wherein said transducer includes a central block having a first portion defined by four planar faces that are each oriented at 90 degrees relative to an adjacent one of said four planar faces, said central block further having a distal end that is a substantially hemispherical shape; said transducer further including four outer blocks each configured to mate to a corresponding one of four piezoelectric crystals positioned adjacent to one of said four planar faces of said central block; each one of said four outer blocks having a first portion having a first arcuate surface and a second portion having a second arcuate surface that is a portion of a spherical surface defined by a hemisphere that includes said distal end of said central block.

11. The apparatus of claim 1 wherein said transducer includes a piezoelectric crystal in electrical communication with said exciter; said transducer further including a pair of blocks wherein each of said pair of blocks is defined by a half-cylinder, said piezoelectric crystal mechanically secured between said pair of blocks, and said pair of blocks emitting ultrasonic waves with a cylindrical wavefront when said piezoelectric crystal is excited by said exciter.

12. An apparatus for a fluid-powered water quality and algae remediation system for immersion in water, said apparatus configured to attach to a fluid port through which a stream of fluid flows, said apparatus comprising:
a power generator module configured to produce electrical power from the stream of fluid;
a block assembly having a first block and a second block, said first and second blocks, and
a piezoelectric crystal having a pair of surfaces, each one of said pair of surfaces being positioned opposite the other one of said pair of surfaces, said piezoelectric crystal positioned between said first and second blocks such that each one of said pair of surfaces is in contact with a flat surface on an adjacent one of said pair of blocks.

13. The apparatus of claim 12 wherein said first block and said second block are mirror images of each other, and said pair of surfaces of said piezoelectric crystal are oriented vertically.

14. The apparatus of claim 12 wherein said first block has a cylindrical shape, said second block has a distal end that is hemispherical, and said pair of surfaces of said piezoelectric crystal are oriented horizontally.

15. An apparatus for a fluid-powered water quality and algae remediation system for immersion in water, said apparatus configured to attach to a fluid port through which a stream of fluid flows, said apparatus comprising:
a turbine having a turbine inlet and a turbine outlet, said turbine having a rotating output, the fluid port in fluid connection with one of said turbine inlet and said turbine outlet such that the stream of fluid flows through said turbine and causes said turbine to rotate said rotating output;
a generator operatively connected to said rotating output of said turbine, said generator having an electrical output;
a water quality module that includes an exciter, and a transducer, said water quality module operatively connected to said electrical output of said generator, said exciter operatively connected to said transducer, and said transducer emits ultrasonic waves when excited by said exciter.

16. The apparatus of claim 15 wherein said transducer has a cylindrical portion that emits ultrasonic waves having a cylindrical wavefront.

17. The apparatus of claim 15 wherein said transducer includes a single piezoelectric crystal and said transducer has a cylindrical portion that emits ultrasonic waves having a cylindrical wavefront.

18. The apparatus of claim 15 wherein said transducer has a hemispherical portion that emits ultrasonic waves having a hemispherical wavefront.

19. The apparatus of claim 15 wherein said transducer includes a single piezoelectric crystal and said transducer has a hemispherical portion that emits ultrasonic waves having a hemispherical wavefront.
